(19) United States
(12) Patent Application Publication
(10) Pub. No.: US 2025/0207455 A1
(43) Pub. Date: Jun. 26, 2025

(54) WINDOW OR DOOR HOLLOW CHAMBER PROFILE AND METHOD FOR PRODUCING THE SAME

(71) Applicant: REHAU INDUSTRIES SE & CO. KG, Rehau (DE)

(72) Inventors: Ahmad AL-SHEYYAB, Rehau (DE); Norbert FINK, Eckental (DE); Stephan SELL, Magdeburg (DE); Horst TIPPENHAUER, Erlangen (DE)

(21) Appl. No.: 18/991,185

(22) Filed: Dec. 20, 2024

(30) Foreign Application Priority Data
Dec. 22, 2023 (DE) 102023136463.4
Mar. 18, 2024 (DE) 102024107662.3

(51) Int. Cl. E06B 3/22

(52) U.S. Cl. CPC E06B 3/22

(57) ABSTRACT

The present invention relates to window or door hollow chamber profile (1), comprising (a) a core profile (30) with a plastic matrix formed from plastic material and reinforcing fibres contained in the plastic matrix; and (b) a sheath layer (40) in the form of a powder coating which at least partially sheathes the core profile (30), wherein the window or door hollow chamber profile (1) is distinguished in accordance with the invention in that the core profile (30) is electrically conductive or statically conductive at least on its surface. In addition, the present invention relates to a method for producing a window or door hollow chamber (1) according to the invention.

### FIELD OF THE INVENTION

The invention relates to a window or door hollow chamber profile which comprises (a) a core profile with a plastic matrix formed from plastic material and reinforcing fibres contained in the plastic matrix; and (b) a sheath layer in the form of a powder coating which at least partially sheathes the core profile. In addition, the present invention relates to a method for producing a window or door hollow chamber profile.

### BACKGROUND OF THE INVENTION

For window and door hollow chamber profiles used to frame glass panes, the aim is to achieve the best possible thermal insulation of the resulting window or door. In order to ensure the mechanical stability required for such windows or doors, it is necessary for structural reasons to insert a metallic reinforcement profile, usually made of steel, into at least one of the cavities of the window or door hollow chamber profile for corresponding window or door hollow chamber profiles made of non-reinforced, thermoplastic material, for example polyvinyl chloride (PVC). The resulting considerable improvement in mechanical stability is accompanied by a significant deterioration in thermal insulation properties due to the thermal bridge created by the reinforcement. To increase stability with good thermal insulation properties, DE 82 02 221 U1, for example, describes a profile strip comprising a polyvinyl chloride core profile containing short glass fibres with a length of up to 12 mm in an amount of up to 50% by weight and a PVC sheath profile with high impact strength sheathing this. In addition, DE 203 02 286 U1 proposes the continuous fibre reinforcement of one or more regions of a window profile made of thermoplastic material with a fibre volume content of more than 20%. Such window and s reinforced with continuous fibres have very high moduli of elasticity. A disadvantage of the profile mouldings described in DE 82 02 221 U1 and DE 203 02 286 U1 is that they cannot be coated with powder coatings under standard conditions applicable to corresponding metal profiles without the resulting powder-coated profile exhibiting significant surface defects.

This is where the present invention comes in, which addresses the problem of providing a window or door hollow chamber profile that at least partially overcomes the disadvantages of the prior art. In particular, the window or door hollow chamber profile according to the invention should have a good surface quality and high mechanical stability even after the surface has been powder-coated. Furthermore, the present invention also lies in the provision of a method for producing such a window or door hollow chamber profile.

These and other problems are solved according to the invention by a window or door hollow chamber profile having the features described herein or by a method having the features described herein. Preferred embodiments of the window or door hollow chamber profile according to the invention and of the method according to the invention are described herein.

### SUMMARY OF THE INVENTION

According to the invention, it has surprisingly been recognised that a high surface quality can also be achieved for powder-coated, fibre-reinforced plastic profiles by making the outer side of the plastic profile to be coated electrically conductive or statically conductive. This leads to better adhesion of the powder coating to the fibre-reinforced plastic profile and to a more compact coating, which results in a good surface quality of the coated plastic profile, which is equivalent to that of corresponding powder-coated metal profiles. According to the present invention, this is realised by making the core profile electrically conductive or statically conductive at least on its surface.

Accordingly, the present invention lies in the provision of a window or door hollow chamber profile which comprises (a) a core profile with a plastic matrix formed from plastic material and reinforcing fibres contained in the plastic matrix; and (b) a sheath layer in the form of a powder coating which at least partially sheathes the core profile, wherein the window or door hollow chamber profile is characterised according to the invention in that the core profile is designed to be electrically conductive at least on its surface.

As used herein, the term “surface resistance” means the electrical resistance measured on the surface of the core profile according to DIN EN 62631-3-2:2016-10, in particular using the “ring electrode” method. In this context, as used herein, the term “electrically conductive” surface is used when the surface resistance is in the range from 10² Ω to 10⁶ Ω. Likewise, as used herein, the term “statically conductive” surface is used in this context if the surface resistance is in the range between 10⁶ and 10⁸ Ω. The lower limit of the surface resistance is preferably 10² Ω, in particular 5*10² Ω. Furthermore, the term “plastic material” describes a plastic, in particular a thermoplastic, to which the additives customary for the manufacture of window or door hollow chamber profiles, such as stabilisers, plasticisers, pigments and the like, have been added. Accordingly, the term “polyamide” in conjunction with a plastic material, for example, means that the additives customary for the manufacture of window or door hollow chamber profiles, such as stabilisers, plasticisers, pigments and the like, have been added to the polyamide as the actual plastic material. The same applies accordingly to polyolefins, polyvinyl chloride (PVC), poly(meth) acrylates, polyesters and the like.

With regard to the window or door hollow chamber profile according to the invention, it may be preferable if the surface resistance of the core profile according to DIN EN 62631-3-2:2016-10 is at most 10⁶ Ω, preferably at most 10000 Ω. Such a value for the surface resistance has proven to be sufficient to achieve powder coatings with a high surface quality that adhere well to the core profile. A value of 100 Ω can be mentioned as the preferred lower limit for the surface resistance.

It may also be favourable if the plastic material of the core profile comprises electrically conductive particles in a proportion of 0.5% by weight to 50% by weight, preferably 1% by weight to 30% by weight, and particularly preferably 5% by weight to 20% by weight, in each case in relation to the weight of the core profile as 100% by weight. Alternatively, it may be useful if the core profile comprises an outer layer containing electrically conductive particles in a proportion of 0.5% by weight to 50% by weight, preferably 1% by weight to 30% by weight, and more preferably 5% by weight to 20% by weight, in each case in relation to the weight of the outer layer as 100% by weight. As a result, the total amount of electrically conductive particles to be used according to the invention can be considerably reduced.

Preferably, the thickness of the outer layer of the core profile is within a range of 0.3 mm to 1.5 mm, in particular within a range of 0.5 mm to 1.0 mm. A thickness of the outer layer in this range sufficiently covers any glass fibres that may occur on the surface.

It may also be advantageous if the electrically conductive particles are selected from electrically conductive carbon black particles and electrically conductive carbon fibre particles, electrically conductive carbon nanotubes, electrically conductive graphite particles, metal particles (in particular copper, aluminium and the like) and combinations thereof. Such particles have been shown to be effective according to the invention and are readily commercially available.

In preferred embodiments of the window or door hollow chamber profile according to the invention, the plastic matrix of the core profile is formed as a polyvinyl chloride matrix, poly(meth) acrylate matrix, polyester matrix or polyamide matrix. Expediently, the plastic matrix of the core profile is formed as a polyacrylate matrix, in particular a PMMA matrix. In this case, the core profile is preferably produced by reactive pultrusion of the corresponding monomers and/or reactive oligomers to produce polyacrylate, e.g. polymethyl methacrylate (PMMA). However, the production of other materials by means of reactive pultrusion, for example polyester, e.g. polyethylene terephthalate (PET), in particular impact-resistant polyethylene terephthalate (PET-G), or polybutylene terephthalate (PBT), or thermoplastic polyurethanes (TPU), is not excluded by this. The production of polyamide, for example PA6 or PA12, or bisphenol A (BPA), polycarbonate (PC), polyester amides or polyimides, preferably by means of reactive pultrusion, is also within the scope of the invention. If the plastic matrix of the core profile comprises a polyamide, the polyamide is preferably selected from the group comprising polyamide-6 (PA 6), polyamide-6.6 (PA 6.6), polyamide-6.10 (PA 6.10), polyamide-4.6 (PA 4.6), polyamide-12 (PA 12) and blends of the aforementioned polyamides. Polyamide-6 is particularly preferred due to its good availability. With regard to reactive pultrusion and the production of window and door hollow chamber profiles by means of reactive pultrusion, reference is made to WO 2018/072878 A1, to which explicit reference is hereby made in this regard.

If an outer layer of the core profile is present, this outer layer is expediently made of a polymer that is compatible with the core profile. Preferably, the material of the outer layer corresponds to the material of the plastic matrix of the core profile. For example, when the thermoplastic matrix of the core profile is formed as a poly(meth) acrylate matrix, it is expedient for the coating to also be made from a poly(meth) acrylate. In principle, the same materials can be used for the coating as for the plastic matrix of the core profile, i.e. in addition to poly(meth) acrylate (e.g. PMMA), in particular polyester (e.g. PET, PET-G or PBT), polyurethanes (e.g. TPU), polyamides (e.g. PA6 or PA12), BPA or PC. Preferably, the outer layer does not comprise any fibre-reinforced material.

Preferably, the outer layer is coextruded with the core profile. The term “coextrusion”, as used herein, also means in this context the application of the coating to the freshly produced core profile by means of an extrusion immediately following the reactive pultrusion online, wherein in this case the intermediate cooling of the core profile prior to the application of the coating is also within the scope of the invention. Alternatively, in coextrusion, the core profile and the coating can be produced in a common mould.

It may be particularly preferable for the plastic matrix of the core profile to be in the form of a polyamide matrix. Preferably, the polyamide is then selected from the group comprising polyamide 6 (PA 6), polyamide 6.6 (PA 6.6), polyamide 6.10 (PA 6.10), polyamide 4.6 (PA 4.6), polyamide 12 (PA 12) and blends of the aforementioned polyamides with each other and with other polymers or copolymers, in particular acrylonitrile-butadiene-styrene copolymers (ABS) and acrylonitrile-acrylic ester-styrene copolymers (ASA). Of these, polyamide-6 is particularly favoured due to its good availability. The thermoplastic material of the outer layer, which is compatible with the plastic material of the core profile, is also preferably selected from these materials. Preferably, the polyamide of the core profile is also used as the thermoplastic material of the sheath profile. In particularly preferred embodiments of the window or door hollow chamber profile according to the invention, polyamide 6 is used as the plastic material of the core profile and the sheath profile.

If an outer layer of the core profile is present, it preferably has a thickness in the range of 0.3 mm to 1.5 mm. According to the invention, the core profile is preferably completely surrounded by the outer layer in cross-section. However, in order to achieve a good external view of the profile, it may also be sufficient if the weather-side outer wall, the room-side outer wall and the fitting-side outer wall of the profile have such an outer layer. The remaining wall thickness of the weather-side outer wall, the room-side outer wall and the fitting-side profile outer wall are then preferably formed by the core profile. As a result, smooth visible surfaces of the structural elements formed from the window or door hollow chamber profile according to the invention are maintained with very high stability of the formed frame. Preferably, the outer layer formed by the casing profile has a thickness in the range from about 0.4 mm to about 1.2 mm, in particular from about 0.5 mm to about 0.9 mm, particularly preferably of about 0.6 mm.

Expediently, the reinforcing fibres are in the form of glass fibres and/or carbon fibres and/or aramid fibres and/or basalt fibres, wherein other fibre materials are not excluded. According to the invention, however, the use of glass fibres as reinforcing fibres contained in the plastic matrix is preferred. In the context of the invention, it is preferred to use short glass fibres with a fibre length in the range from 0.1 mm to 5 mm, long glass fibres with a fibre length in the range from 5 mm to 50 mm and/or continuous glass fibres with a length of more than 50 mm, either individually or in combination. While the core profile is preferably produced by extrusion or coextrusion when using short and long glass fibres, the production of the window or door hollow chamber profile according to the invention by means of reactive pultrusion is most suitable when using continuous glass fibres. When using short glass fibres, it can also be advantageous if the average fibre length of the reinforcing fibres is in the range of 1.5 mm to 3.2 mm. An average length of the glass fibres in this range leads to a high mechanical stability of a window or door hollow chamber profile according to the invention, both in the longitudinal direction and perpendicular thereto. In this context, an average fibre length in a range of 2.5 mm to 3.0 mm has proven to be particularly suitable. According to the invention, the use of continuous glass fibres is particularly preferred. There is the greatest need to improve the surface quality for continuous glass fibres. In addition, the highest stiffness and strength values with a modulus of elasticity according to DIN EN ISO 527-4:2022-03 of up to 70,000 N/mm² in the longitudinal direction of the profile are achieved using continuous glass fibres.

It can also be helpful if the reinforcing fibres are contained in the core profile in a proportion of 10% to 90% by weight, in relation to the weight of the core profile as 100% by weight. If the proportion by weight of the reinforcing fibres in the core profile is within the range of 10% to 90% by weight, in relation to the weight of the core profile as 100% by weight, excellent moduli of elasticity according to DIN EN ISO 527-4:2022-03 and corresponding core profiles can be produced, for example, by means of reactive pultrusion. In this context, it is preferable if the proportion by weight of the reinforcing fibres in the core profile is within the range of 20% by weight to 80% by weight, in particular 30% by weight to 60% by weight, in each case in relation to the weight of the core profile as 100% by weight.

With regard to the sheath layer formed as a powder coating, materials and application and curing processes known to a person skilled in the art per se can be used in accordance with the invention. For example, powder coating compositions based on polyester resins, epoxy resins and/or (meth) acrylate resins and mixtures thereof, which may also contain crosslinking resins (curing agents), pigments, fillers and other coating additives, can be used according to the invention. Epoxy resins, polyester resins and mixtures containing these have proven to be particularly suitable according to the invention, as they best wet the surfaces of the plastic profiles. To cure powder coatings, it is necessary to first melt the powder deposited on the substrate by heating it to temperatures above the glass transition temperature or the melting point of the powder coating formulation. Convection ovens, infrared emitters or a combination of both are used as heat sources. For thermally cross-linking systems, the powder coating is typically cured by heating it to temperatures between 140 and 200° C. for a period of approximately 10 to 30 minutes. For UV-curing powder coating formulations, the curing of the molten powder coating takes place within a few seconds with the aid of ultraviolet radiation. In preferred embodiments of the window or door hollow chamber profile according to the invention, the powder coating has a thickness in a range from 25 μm to 200 μm, in particular in a range from 60 μm to 120 μm.

All plastic materials in the window or door hollow chamber profile according to the invention can also be used in the form of materials obtained by a recycling process. In particular, it is preferable that a recycled polyamide is contained in the core profile. In addition or alternatively, “fresh”, i.e. non-recycled, polymer material can also be used in the casing profile.

Particularly preferably, the core profile of the window or door hollow chamber profile according to the invention can be produced in a manner known per se by coextrusion of the core profile and the casing profile.

Preferably, the window or door hollow chamber profiles according to the invention are used to manufacture a plastic window or a plastic door. A window or door frame can be obtained by welding mitre-cut pieces of a window or door hollow chamber profile according to the invention or connecting such pieces by means of corresponding corner connectors. The window or door frame is intended for installation in an opening in a wall of a building or can be installed in the opening in the wall of a building.

The explanations with regard to the window or door hollow chamber profile according to the invention apply accordingly with regard to the method according to the invention.

With regard to the method according to the invention, it is preferable if the core profile is produced, possibly together with the outer layer, by means of extrusion, coextrusion or pultrusion, in particular by means of reactive pultrusion.

The window or door hollow chamber profile according to the invention as well as individual parts thereof can also be manufactured line by line or layer by layer using a line-building or layer-building manufacturing process (e.g. 3D printing), but manufacturing by means of the method according to the invention is preferred.

### BRIEF DESCRIPTION OF THE DRAWINGS

In the following, the present invention will be explained in detail with reference to the embodiments shown in the figures. A cross-sectional view of a window or door hollow chamber profile formed as a window sash profile according to one embodiment of the present invention is shown.

FIG. 1 shows an embodiment of the window or door hollow chamber profile 1 according to the invention using the example of a sash profile for a plastic window in a cross-sectional view. The window or door hollow chamber profile 1 according to the invention comprises a weather-side outer wall 2 and a room-side outer wall 3. Two cavities 4, 5 adjoin the weather-side outer wall 2 and are bounded by walls 6, 6′, 6″ formed as webs and the weather-side outer wall 2. In the centre, the cavity profile 1 according to the invention comprises a main cavity 7. The upper web 8 of the main cavity 7, together with an outer folded-over portion 5, forms a rebate region 10, in which a panel element, not shown, in particular an insulating glazing unit, can be accommodated. The panel element is stabilised by a glazing bead (not shown), which can be anchored in a glazing bead groove 11 of the cavity profile 1 according to the invention. The outer wall 12 of the cavity profile 1 according to the invention, which is arranged at the bottom in FIG. 1, is referred to as the fitting-side profile outer wall 12, while the side opposite the fitting side is referred to as the rebate side with a rebate-side profile outer wall 13.

### DETAILED DESCRIPTION OF EMBODIMENTS OF THE INVENTION

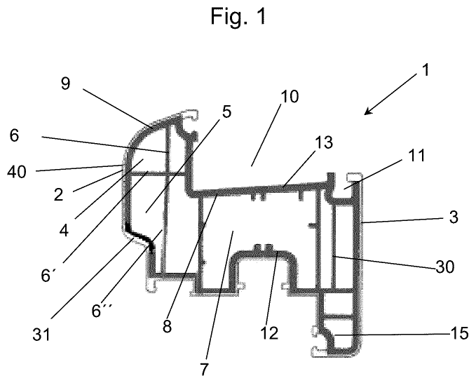

In the embodiment of the window or door hollow chamber profile 1 according to the invention shown in FIG. 1, the core profile 30 forms the inner walls, for example the walls 6, 6′, 6″, the rebate-side profile outer wall 13 and portions of the glazing bead groove 11 completely, as well as the weather-side outer wall 2, the fitting-side profile outer wall 12 and the room-side outer wall 3 partially directed towards the inside of the profile. The remaining parts of the wall thickness of the weather-side outer wall 2, the room-side outer wall 3, the glazing bead groove 11, the fitting-side profile outer wall 12 and the stop 14 are formed by an outer layer 31. The outer layer 31 thus partially forms the outer side of the core profile 30. This outer side of the core profile 30 is completely encased by a sheath profile 40 in the form of a powder coating. In the embodiment shown, the sheath profile 40 has a thickness of 80 μm.

According to the embodiment of the window or door hollow chamber profile 1 according to the invention shown in FIG. 1, the core profile 30 comprises a plastic matrix of polyamide 6, to which additives customary for the extrusion of window or door hollow chamber profiles, such as stabilisers, plasticisers, pigments and the like, are added. Short glass fibres with an average fibre length of 2.7 mm are embedded in the plastic matrix for reinforcement in a proportion of 45% by weight, in relation to the weight of the core profile 30 as 100% by weight. The outer layer 31 forms a mixture of electrically conductive polyamide 6 (Percolen PA 4200 EC; obtained from Grafe GmbH & Co. KG, D-99444 Blankenhain) and conventional polyamide 6, wherein the additives customary for the extrusion of window or door hollow chamber profiles have also been added to the mixture. This mixture is compatible with the core profile 30. By varying the proportion of electrically conductive polyamide 6 in the mixture, the surface resistance of the core profile 30 was adjusted to various values ranging from 500 Ω to 10⁸ Ω in accordance with DIN EN 62631-3-2:2016-10.

A polyester-based powder coating (TIGER Drylac® Series 068 smooth semi-gloss; obtained from TIGER Coatings GmbH & Co. KG, A-4600 Wels) was then applied to the resulting profiles and to the core profile 30 without outer layer 31, each with a layer thickness of 80 μm, and cured.

In the case of the core profile 30 without outer layer 31, i.e. without an electrically conductive surface (reference example), the surface exhibits several large bubbles after hardening. In contrast, the window profiles 1 according to the invention in the regions with an outer layer 31, i.e. with an electrically conductive surface (examples according to the invention), showed a smooth surface texture after hardening, which was similar to that of powder-coated aluminium profiles, as well as good paint adhesion, while in the regions without an outer layer 31, several large bubbles appeared on the surface.

Corresponding window profiles 1 were also produced with polyvinyl chloride, epoxy resins and (meth) acrylate resins, with comparable results being achieved.

In alternative embodiments, the core profile 30 is also formed entirely from the electrically conductive plastic material with reinforcing fibres embedded therein (without outer layer 31). In such cases, powder coatings that adhere well to the core profile 30 are also obtained with good surface quality.

The window profiles 1 according to the embodiment of the present invention shown in FIG. 1 have very good weather resistance and high mechanical stability both in the longitudinal direction (modulus of elasticity according to DIN EN ISO 527-4:2022-03 of 9,400 N/mm2) and perpendicular thereto.

The window profile 1 according to the invention was produced by coextrusion of the core profile 30 with the outer layer 31 and subsequent application of the outer layer 40 by powder coating.

The present invention has been described by way of example with reference to cavity profiles for the sash frame of a window. It is to be understood that the present invention is also applicable to other window or door hollow chamber profiles, in particular frame profiles for a window as well as for frame, architrave or sash frame profiles of a door accordingly.

1. A window or door hollow chamber profile, comprising
(a) a core profile with a plastic matrix formed from plastic material and reinforcing fibres contained in the plastic matrix; and
(b) a sheath layer in the form of a powder coating which at least partially sheathes the core profile,
wherein
the core profile is electrically conductive or statically conductive at least on its surface.

2. The window or door hollow chamber profile according to claim 1, wherein the surface resistance of the core profile according to DIN EN 62631-3-2:2016-10 is at most 10⁸ Ω, preferably at most 10⁶ Ω.

3. The window or door hollow chamber profile according to claim 1, wherein the plastic material of the core profile contains electrically conductive particles in a proportion of 0.5% by weight to 50% by weight, in relation to the weight of the core profile as 100% by weight.

4. The window or door hollow chamber profile according to claim 1, wherein the core profile comprises an outer layer containing electrically conductive particles in a proportion of 0.5% by weight to 50% by weight, in relation to the weight of the outer layer as 100% by weight.

5. The window or door hollow chamber profile according to claim 4, wherein the thickness of the outer layer of the core profile is within a range of 0.3 mm to 1.5 mm.

6. The window or door hollow chamber profile according claim 3, wherein the electrically conductive particles are selected from electrically conductive carbon black particles and electrically conductive carbon fibre particles, electrically conductive carbon nanotubes and combinations thereof.

7. The window or door hollow chamber profile according to claim 1, wherein the plastic matrix of the core profile is formed as a polyvinyl chloride matrix, poly(meth) acrylate matrix, polyester matrix or polyamide matrix.

8. A method for producing a window or door hollow chamber profile according to claim 1, wherein the core profile is first produced by means of a strand production process and then the sheath layer is applied in the form of a powder coating.

9. The method according to claim 8, wherein the core profile is produced by means of extrusion, coextrusion or pultrusion, in particular by means of reactive pultrusion.
